(19) United States
(12) Patent Application Publication
(10) Pub. No.: US 2023/0396728 A1
(43) Pub. Date: Dec. 7, 2023

(54) COLOR PREDICTION IN MULTIPLE CONTEXTS

(71) Applicant: Hewlett-Packard Development Company, L.P., Spring, TX (US)

(72) Inventors: Jan MOROVIC, London (GB); Peter MOROVIC, Sant Cugat del Valles (ES)

(73) Assignee: Hewlett-Packard Development Company, L.P., Spring, TX (US)

(21) Appl. No.: 18/249,081

(22) PCT Filed: Oct. 16, 2020
(86) PCT No.: PCT/US2020/056057

§ 371 Date: Apr. 14, 2023

(51) Int. Cl. H04N 1/60

(52) U.S. Cl. CPC H04N 1/6033

(57) ABSTRACT

Certain examples relate to a method of a method of color prediction in multiple rendering contexts. In one example the method determines a plurality of color prediction models for respective color rendering contexts, each color prediction model mapping between a device dependent color and a rendered color. Measurement data of the rendered color in one said context obtained and mapped to a corrected device color. The corrected device color may be used to predict rendered corrected color for another said context using respective color prediction models.

### BACKGROUND

Color printing may result from a number of colorants of different colors being superimposed on top of a substrate, such as paper or other media. A printing system may be associated with a color space, defined by one or more colorants available to the printing system for deposition or application to a print medium. An example of a colorant color space is the Cyan, Magenta, Yellow, BlacK (CMYK) color space, wherein four variables are used in a subtractive color model to represent respective quantities of colorants. Measurements of test prints may be used to develop color prediction models which can be used to predict printed colors from colors in a device specific color space. Color prediction models may also be developed for other types of color rendering, such as display devices or projecting onto surfaces.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic illustration of a color rendering system according to an example;

FIG. 2 is a schematic of an apparatus according to an example;

FIG. 3 is a flow chart showing a method of operating a printing apparatus according to an example; and

FIG. 4 illustrates prediction of rendered colors in different rendering contexts according to an example

### DETAILED DESCRIPTION

Color can be represented within imaging devices such as print and display devices in a variety of ways. For example, in one case, a color as observed visually by an observer is defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of one or more people. These categories can then be modelled using a lower number of variables.

Within this context, a color model may define a color space. A color space in this sense may be defined as a multi-dimensional space, with a point in the multi-dimensional space representing a color value and dimensions of the space representing variables within the color model. For example, in a Red, Green, Blue (RGB) color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. Other color spaces include: a Cyan, Magenta, Yellow and Black (CMYK) color space, in which four variables are used in a subtractive color model to represent different quantities of colorant or printing fluid, e.g. for a printing system; the International Commission on Illumination (CIE) 1931 XYZ color space, in which three variables (X, Y and Z or tristimulus values) are used to model a color; the CIE 1976 (L*, a*, b*—CIELAB or ‘LAB’) color space, in which three variables represent lightness (L*) and opposing color dimensions (a* and b*); the YUV color space, in which three variables represent the luminance (Y) and two chrominance dimensions (U and V); and the IPT color space, in which the three variables represent a lightness or Intensity dimension (I), a “Protanopia” red-green chroma dimension (P), and a “Tritanopia” yellow-blue chroma dimension (T).

An image to be printed may be described by image data which may comprise a number of pixels or elements of the image which are each associated with a color value in a color space. The color values of the image data may need to be converted into a different color space specific to a printing apparatus for printing the image. For example, an image defined according to an RGB color space may need to be redefined in a CMYK color space corresponding to colorants available to the printing apparatus. A specific combination of colorants or inks to be printed may be specified as an ink-vector, which corresponds to the colorant amount per colorant for each pixel of an image to be printed.

Other color spaces include area coverage spaces, such as the Neugebauer Primary area coverage (NPac) color space. An NPac vector in the NPac color space represents a statistical distribution of Neugebauer Primaries (NPs) over an area of a halftone. In a simple binary (bi-level, i.e. two drop states: “drop” or “no drop”) printer, an NP may be one of 2^{k}−1 combinations of k printing fluids within the printing system, or an absence of printing fluid (resulting in 2^{k} NPs in total). An NP may thus be seen as a possible output state for a print-resolution area. The set of NPs may depend on an operating configuration of a device, such as a set of available colorants. A colorant or printing fluid combination as described herein may be formed of one or multiple colorants or printing fluids. For example, if a bi-level printing device uses CMY printing fluids there can be eight NPs or output states. These NPs relate to the following: C, M, Y, CM, CY, MY, CMY, and W (white or blank indicating an absence of printing fluid). An NP may comprise an overprint of a plurality of available printing fluids, such as a drop of magenta on a drop of cyan (for a bi-level printer) in a common addressable print area (e.g. a printable “pixel”). An NP may be referred to as a “pixel state”.

An NPac space provides a large number of metamers. Metamerism is the existence of a multitude of combinations of reflectance and emission properties that result in the same perceived color for a fixed illuminant and observer. Multiple NPac vectors in an NPac space may have a similar colorimetry (e.g. a similar representation in a color space with three dimensions). Several NPac vectors may thus be useable to represent a given color. Different NPac vectors that have similar colorimetry may, however, have differing attributes or properties other than colorimetry (e.g. different appearances under different illuminants).

Each NPac vector may therefore define a probability distribution for colorant or printing fluid combinations for each pixel in the halftone (e.g. a likelihood that a particular colorant or printing fluid combination or available output state is to be placed or defined at each pixel location in the halftone). In this manner, a given NPac vector defines a set of halftone parameters that can be used in the halftoning process to map a color to NPs to be statistically distributed over the plurality of pixels for a halftone. Moreover, the statistical distribution of NPs to pixels in the halftone serves to control the colorimetry and other print characteristics of the halftone.

A simple color space may be defined using ink vectors which represent the proportion of individual inks within a combination such as an NPac vector. For example, an ink vector may be a vector with a predefined set of elements, where each element represents an ink (e.g. a colorant or color output available to the rendering device) and the value of the element represents a quantity of ink (e.g. [C, M, Y, K]). An ink vector may be used to instruct deposit of inks in a printing device, e.g. where the value represents a particular number of drops or quantity of ink to deposit. An ink vector may be used to instruct the printing of a color in an addressable area of a substrate (e.g. a print “pixel”).

A colorant may be a dye, a pigment, an ink, or a combination of these materials. A substrate may include various types of paper, including matt and gloss, cardboard, textiles, vinyl, plastics and other materials.

A color prediction model (CPM) may be developed to map between a device dependent color space and corresponding output (e.g., printed, displayed, projected) colors. The CPM may be used to predict output color properties for a color in a device dependent color space such as RGB, CMYK, NPac, or other color spaces. For example, a particular “red” in the CMYK color space of a particular printing device may be rendered on a substrate as a “red” having certain measurable properties or colorimetry. Examples of colorimetry measurement include tristimulus colorimeter, spectroradiometer, spectrophotometer, and many others

Measurement data for a range of printed, displayed or projected colors can be obtained from suitable measurement devices, for example by rendering or printing a number of color ramps or other predetermined test patterns. The colorimetry from these different colors can be used together with the original colors in the device depending color space to develop a CPM for the device which maps between the colors in one color space (printed) to another color space (device dependent e.g. CMYK).

Because different types of substrate will have different interactions with dispensed colorant, for example different absorption and chemical reactions, the printed color may appear different on one substrate compared with another, even when the same device dependent color has been printed. Therefore, a CPM is developed for each substrate that a printer prints onto. Similarly, colors rendered in other contexts may be affected by properties of those contexts such as smooth compared with rough projection surfaces and display devices using different display technologies.

A printer may need recalibration or reprofiling periodically, for example because as the printer ages the amount of colorant dispensed may change which affects the printed color. In order to compensate for changes in printer performance, it may be possible to recalibrate the printer to improve its performance, for example to increase the amount of colorant dispensed per drop. The printer may also be reprofiled where the CPM is redeveloped based on the changes in printer performance due to aging and/or due to recalibration. This involves reperforming test printing and measurement for each substrate. Similarly a display device or projector may need recalibration or reprofiling periodically, for example due to aging component parts.

Certain examples described herein address a challenge with profiling or calibrating rendering apparatus for different rendering contexts. Here rendering context refers to the combination of rendered substrate and post-rendering processing (if any). For example a context may simply involve printing onto a certain substrate such as paper or textile, but it may also involve post-printing processes such as varnishing or laminating the printed paper or calendering the printed textile, all of which will affect the measurement of rendered colors. Other rendering contexts include displaying color on different types of display devices, for example using LED or OLED technologies. Different types of projectors may project onto different projection surfaces corresponding to different rendering context. Obtaining color measurements for each rendering context for a rendering apparatus is time consuming and expensive.

Certain examples described herein allow retesting and measuring printed colors for one rendering context to be used for printing in other rendering contexts as well. This avoids having to repeat measurements for each printing context when the printer needs recalibration or reprofiling. Certain other examples allow retesting and measuring rendered colors using a display or projection surface rendering context to be used for rendering in other rendering contexts.

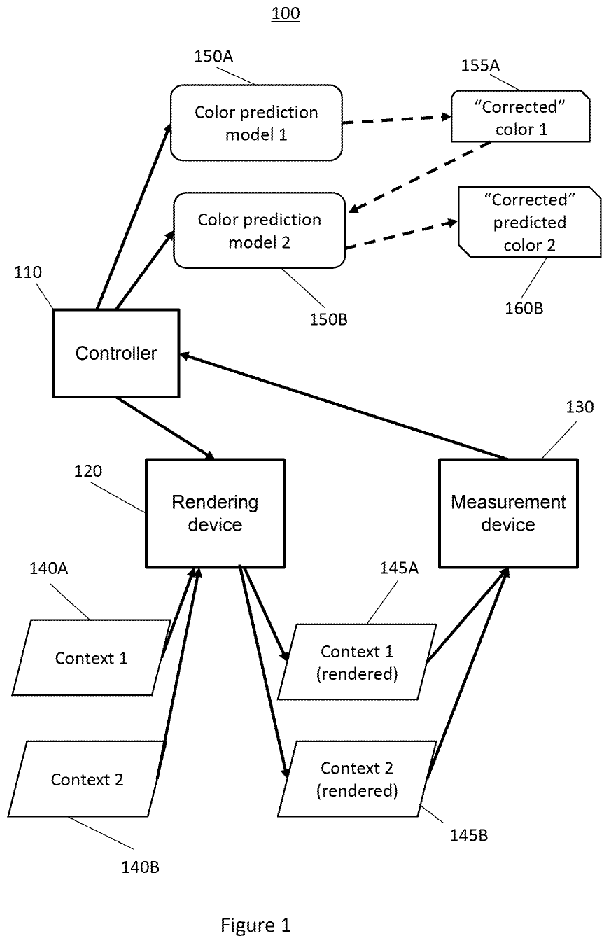

FIG. 1 shows a color rendering apparatus 100 according to an example. The apparatus 100 comprises a controller 110 which controls a rendering device 120 and a measurement device 130. In an example, the controller 110 may be implemented in an example as a processor and memory with processor readable instructions although any suitable controller implementation could alternatively be used.

In an example, the color rendering device 120 is a printhead having a plurality of inkjet nozzles for ejecting ink or other colorants onto the substrate to print an image according to image data received by the apparatus. The printhead may be mounted on a moveable carriage to move across the substrate whilst ejecting colorant, although pagewide printhead may alternatively be used in which the printhead spans the width of a substrate and does not move across the substrate. In another example, the color rendering device 120 is a projector which projects colored light onto a surface. In another example, the color rendering device 120 is a display device which has different modes of display, for example a night viewing mode in which certain colors are more muted than in a day viewing mode; or a reduced power mode for low battery operation where high intensity color reproduction is reduced.

In an example the measurement device is one or a combination of the following: tristimulus colorimeter, spectroradiometer, spectrophotometer, densitometer. The measurement device 130 generates measurement data by measuring color related properties of a substrate onto which the printing device 120 has printed colors such as predetermined test patterns including color ramps.

As illustrated, the rendering device 120 may render in two (or more) rendering contexts 140A and 140B. In an example, the color rendering apparatus is a color printing apparatus and the rendering contexts correspond to different printing contexts which have different substrates and/or different post-processing. For simplicity of explanation the terms rendering context and printing context are used interchangeably although it will be understood that rendering context could also refer to projection context and display device context. In an example, Context 1 140A may be a particular paper substrate without any postprocessing and Context 2 140B may be a particular textile substrate with calendaring post-processing. The printing device 120 deposits colorant onto the two substrates according to the same test patterns and performs the post-processing, if any, to generate printed substrates 145A and 145B respectively. Because of the different substrates and post-processing the printed colors of the two printed substrates 145A, 145B are likely to differ from each other even though the same device dependent colors were used by the printing device 120 to print the test patterns.

The measuring device 130 measures both printed substrates 145A, 145B to generate respective measurement data. By comparing the device dependent colors used in the test pattern with the measured colors a color prediction model (CPM) can be generated for each printing context 140A, 140B. As shown respective CPM 150A and 150B are generated for printing contexts 140A and 140B. CPM may be generated using any suitable method and for any number of printing contexts that may be used by the printer by printing and measuring test patterns in the respective printing contexts. Such printing contexts may include for example multiple types of paper substrate without post-processing, those same paper substrates with varnishing or lamination, multiple types of textiles with or without calendaring, vinyl and other types of substrates. Therefore, the printing apparatus 100 may be associated with a number of CPM each for a different printing context and which enables mapping between device dependent colors such as in CMYK space to and from printed colors on the respective substrate.

The CPM allows the printed color for any printing context to be predicted and can be used to profile the printing apparatus 100 for different printing contexts. Profiling adjusts device dependent color data for the printing device with the aim of achieving a desired printed color. The printing apparatus 100 may also be calibrated for different printing contexts using the respective CPM. Calibration optimizes printing apparatus parameters such as NPac vectors or ink vectors, for example some absorbent textile substrates may require additional colorant to be added to achieve a desired printed color compared with a glossy paper substrate and so additional or larger drops of ink may be used for some printing contexts.

As the printing apparatus ages, various printing characteristics may change such as the size and/or weight of drops of colorant applied to substrate, which affects the printed color. In order to address this, the printing device 120 is controlled by the print controller to print another test pattern in one of the printing contexts 140A. The printing context 140A used may be a simple and cheap one such as paper without any post-processing. The printed substrate 145A is then remeasured by the measuring device 130 to generate new measurement data for the selected printing context. The measured colors of the test pattern may have changed since the previous measurement due to aging of the printing apparatus 100. The new measurement data may be used to reprofile and/or recalibrate the printing apparatus for the corresponding printing context.

The new measurement data is also mapped by the CPM 150A for the printing context to a “corrected” color 155A in the device dependent color space, for example CMYK. This corrected color may be different from the original color in the device dependent color space used to print the test pattern. In practice a number of colors will be used on the test pattern corresponding to the color gamut of the printing apparatus and a corresponding number of corrected colors is obtained across the gamut.

Once the corrected colors are obtained for one printing context 140A using the corresponding CPM 150A, the corrected colors may be mapped by the CPM 150B of another printing context 140B to predict the printed colors for the other printing context 140B. These corrected predicted colors 160B may then be used to reprofile and/or recalibrate the printing apparatus 100 for the respective printing context 140B. This process may be repeated for all other printing contexts for which the printing apparatus already has a CPM. Therefore, according to this example, when the printing apparatus 100 needs to be reprofiled or recalibrated, printing and measuring of the test pattern can be performed in just one (or a reduced number of) printing context 140A. Reprofiling or recalibration for other printing contexts 140B can be achieved without printing and measuring the test pattern in those other printing context 140B. Instead, the corrected colors determined by mapping the new measurement data through the CPM 150A of the remeasured printing context can then be mapped by the other CPM 150B to predict printed colors for the other contexts and in turn used for reprofiling or recalibrating the printing apparatus for those other printing contexts. This reduces the time taken to reprofile or recalibrate the printing apparatus 100 as well as reducing the material and post-processing costs associated with printing the test pattern again on all printing contexts.

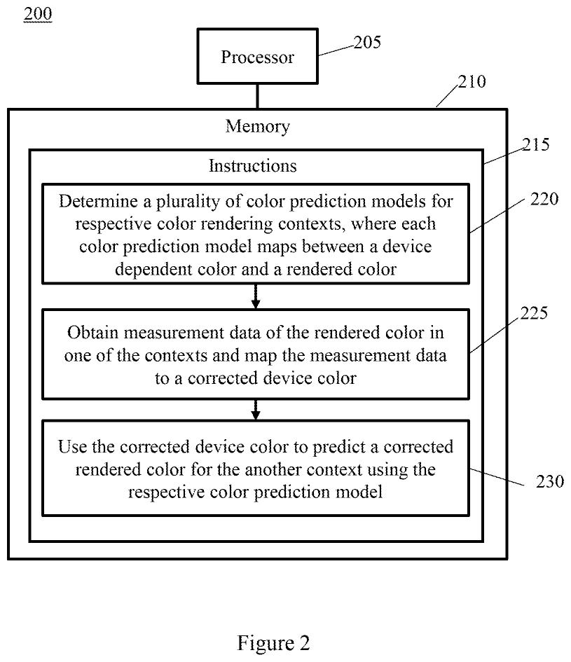

FIG. 2 illustrates shows a color rendering apparatus 200 according to an example. The apparatus comprises a processor 205 coupled to a memory 210 containing computer-readable instructions 215. The processor 205 may be any suitable processor type and may be the processor of the print controller 110. The computer-readable instructions 215 in the memory 210 may be used to implement the above described behavior. The memory may be a non-transitory computer-readable storage medium for example, a hard drive, a CD-ROM disc, a USB-drive, a solid-state drive or any other form of magnetic storage device, optical storage device, or flash memory device, maintained locally or accessed remotely, capable of having thereon computer readable code suitable for the functions described herein.

Instruction 220 instructs the processor to determine a plurality of color prediction models (CPM) for respective color rendering contexts where each image data for an image to be rendered, where each CPM maps between a device dependent color and a rendered color. The CPM may be determined as described above by rendering tests patterns in each rendering context and using a measuring device to obtain corresponding measurement data. The measurement data for each rendering context can then be compared to the device dependent color used to render the test pattern in order to generate respective CPM. Alternatively, the CPM may be downloaded or otherwise received from a remote source, such as the manufacturer.

Instruction 225 instructs the processor to obtain measurement data of the rendered color in one or a reduced number of rendering contexts and to map this to a corrected device dependent color. The measurement data may be obtained from a measuring device which measures a rendered substrate rendered with a test pattern including the rendered color. This measurement data corresponds to a more recent rendered substrate than any used for developing the CPM. The new measurement data reflects aging of the rendering apparatus compared with when the CPM were generated and may correspond to different printed colors due to reduced colorant volume or weight compared with when a printing rendering apparatus was newer. Other examples of aging may include LED degradation in display devices and lens decay in projectors. This may result in a corrected color in device dependent color space which is different from the color used to render the original and latest test patterns.

Instruction 230 instructs the processor to predict a corrected rendered color for another printing context using the CPM for that other rendering context. This may be achieved by mapping the corrected color in device dependent color space to a predicted corrected rendered color using the CPM originally developed for the rendering context of interest. These predicted corrected rendered colors for each rendering context may then be used for reprofiling or recalibrating the rendering apparatus for each rendering context.

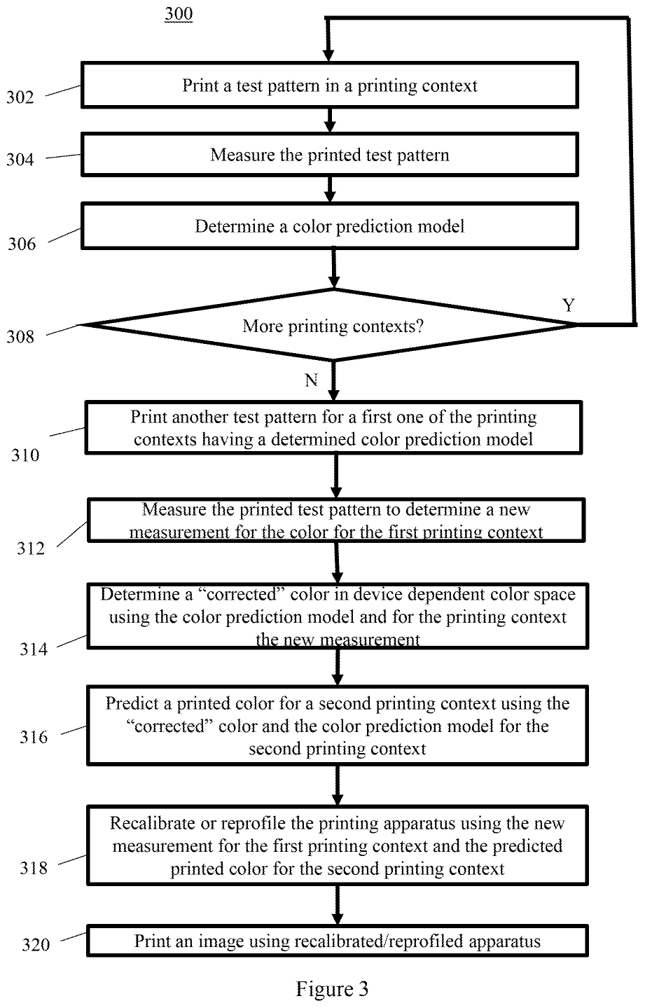

FIG. 3 illustrates a method of operating a printing apparatus according to an example. The method 300 may be performed in association with apparatus 100 of FIG. 1 or the apparatus 200 of FIG. 2, or in any suitable color rendering system. Different parts of the method 300 may be performed by different components of a color rendering device. Parts of the method 300 may also be performed in a different order to that illustrated.

At item 302, the method 300 comprises printing a test pattern in a printing context, for example a particular type of glossy paper. The test pattern may be a series of color ramps where a predetermined number of colors are printed in bars or dots of increasing coverage area, gray level or amounts of ink.

At item 304, the method 300 comprises measuring the printed test pattern. Colorimetry parameters for each bar or dot of each color and each ink amount, gray level or other aspects of each part of the pattern are measured to generate measurement data. This may be implemented using any suitable colorimetry measuring equipment such as tristimulus colorimeter, spectroradiometer, spectrophotometer, densitometer.

At item 306, the method 300 comprises determining a color prediction model (CPM) for the printing context. This is generated using the measurement data for the or each printed color in the test pattern as well as the corresponding device dependent color(s) used to print the test pattern. Any suitable methods of generating CPM can be used. For example, a supervised learning/regression approach may be used such as polynomial regression, progressive polynomial regression and neural networks including deep learning. Another approach is to use domain-specific analytical models such as Neugebauer, Yule-Nielsen and Kubelka-Munk.

At item 308, the method 300 determines whether there are any more printing contexts to characterize. For example, if further types of glossy paper, matt paper, cardboard, textiles and other substrate and/or post-processing need to be have a corresponding CPM developed, then the method returns to item 302. If all printing contexts for the printing apparatus have been processed to find respective CPM, then the method moves to item 310.

At item 310, the method again prints a test pattern for one of the printing contexts where a CPM is already available. This will usually be performed some time after the initial printing at item 302 and corresponds to a more aged printing apparatus. For example, additional test prints for one of the printing contexts may be periodically printed and used to recalibrate or reprofile the printing apparatus.

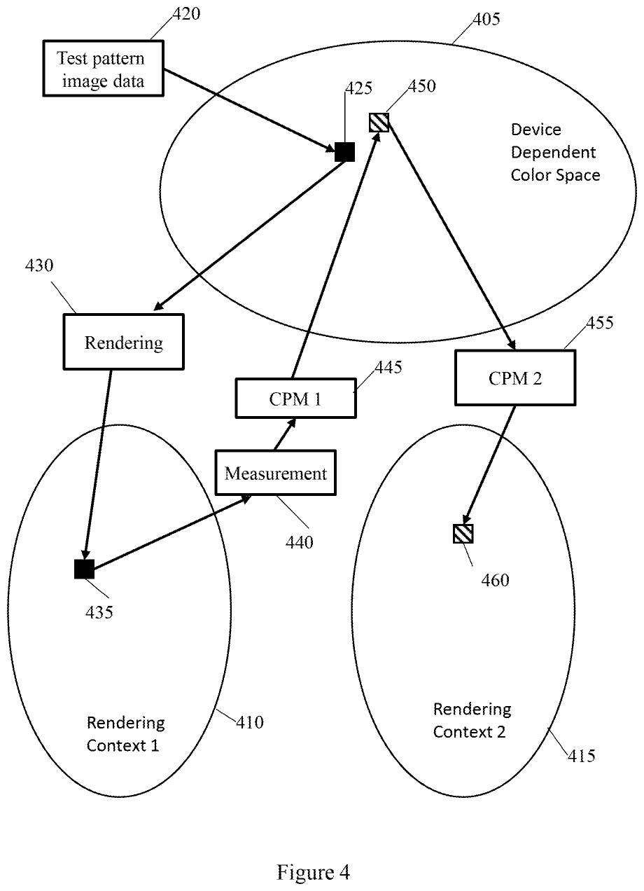

This process can also be seen in FIG. 4 which illustrates predicting rendered colors in different contexts using the method of FIG. 3. Test pattern image data 420 is represented in a device dependent color space 405 such as CMYK. For example, a particular color 425 is shown at a particular location or coordinates within the device dependent color space 405. This may include various conversions or processes to convert the test pattern data from a device independent color space to the device dependent color space 405, for example color separation and other color pipeline processing. The illustrated device dependent color space 405 represents all possible colors that can be printed by the printing apparatus or its gamut. The illustrated approach of FIG. 4 is also applicable to other color rendering apparatus such as projectors or display devices having different respective projection and display device contexts.

The device dependent color 425 is printed in a first printing context by a printing process 430. The printing process may involve further conversions and processing such as ink-vector to NPac conversion, halftoning, printhead control and so on. The printing process 430 will be dependent on the printing context, for example additional ink may be used for absorbent paper compared with glossy paper. As a result, the device dependent color 425 is deposited onto a substrate which may or may not undergo post-processing. The resulting printed color 435 can be represented in a color space 410 corresponding to the first printing context.

At item 312, the method 300 measures the latest printed test pattern to determine new measurement data for the first printing context. Due to aging processes in the printing apparatus, the printed colors may differ from those printed at the initial printing and measuring items 302 and 304. For example, the printing apparatus may eject drops of ink having lower volume or weight as the printing apparatus ages, even though the same device dependent colors are used to control printing. This can be seen in FIG. 4 by a measurement process 440 measuring and generating measurement data corresponding to the printed color 435.

At item 314, the method determines a “corrected” color in the device dependent color space using the CPM of the first printing context, for example as previously described. In FIG. 4, this is illustrated by mapping the measurement data from the measurement process 440 back into the device dependent color space 405 using the CPM 445 of the printing context used to print the color. This effectively maps the measurement of color 435 in the first printing context color space 410 to color to corrected color 450 in the device dependent color space 405. Corrected color 450 is in a different location compared with the original color 425, for example due to changes in the printing process over time. The corrected color 450 corresponds to what the printing apparatus should print when receiving image data containing the device dependent color 425. In other words the device dependent colors should be corrected to compensate for changes in printing characteristics over time. The corrected colors are in the device dependent color space, and not specifically the first printing context, and so can be used for other printing context with appropriate conversion.

At item 316, the method 300 predicts a printed color for a second printing context using the corrected color and the CPM for the second printing context. This is illustrated in FIG. 4 as mapping the corrected color 450 into a color space 415 for a second printing context using a CPM 455 for that printing context. The predicted printed color 460 for the second printing context 415 may have different coordinates compared with the printed color 435 of the first printing context 410. The gamuts of the two printing context color spaces 410 and 415 may also be different. Once corrected colors 450 have been determined using measured printed colors 435 from one printing context 410, these corrected colors 450 can be applied to any other printing context 415 using the corresponding CPM 455. This allows the printed colors for all printing contexts for which the printing apparatus has a CPM to be predicted.

At item 318, the method recalibrates or reprofiles the printing apparatus. This can be done using predicted printed colors 460 for different printing contexts. This allows the printing apparatus to compensate for the effects of aging such as reduced ink drop weight. This avoids having to print test patterns again for all printing contexts and measuring the colors of the test patterns for each printing context. Instead, once the corrected colors are determined, these can be used to predict printed colors for each printing context and these predicted printed colors are used as the measured colors for recalibration or reprofiling.

At item 320, an image is printed using the recalibrated and/or reprofiled printing apparatus. This allows for the effects of aging of the printing apparatus to be compensated. Steps 310 to 318 may be repeated periodically to ensure optimal printing.

The method may be applied to a printing apparatus having HANS pipeline using NPacs or a non-HANS pipeline using ink-vectors for example.

Whilst some examples have been described in detail relating to printing apparatus, other examples relating to other color rendering devices such as display devices and projectors can also employ corresponding methods and color space interactions. CPM for rendering contexts for other types of rending apparatus may also be developed and used for reprofiling or recalibrating the apparatus by rendering and remeasuring in just one rending context.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples

What is claimed is:

1. A method comprising:
determining a plurality of color prediction models for respective color rendering contexts, each color prediction model mapping between a device dependent color and a rendered color;
obtaining measurement data of the rendered color in one said context and mapping the measurement data to a corrected device color;
using the corrected device color to predict rendered corrected color for another said context using the respective color prediction models.

2. The method of claim 1, wherein obtaining the measurement data comprises rendering the device dependent color in the context and measuring the rendered color.

3. The method of claim 1, wherein determining the plurality of color prediction models comprises rendering the device dependent color for each respective rendering context and measuring the rendered color to obtain initial measurement data for each respective rendering context, using the device dependent color and the initial measurement data for each rendering context to determine the respective color prediction models.

4. The method of claim 1, wherein the rendering contexts comprise: printing substrates selected from the following group: paper, vinyl, textile, plastic, and post-processing selected from the group: no post-processing, varnishing, laminating, calendering; display screens; projectors projecting onto a predetermined surface.

5. The method of claim 1, comprising using the predicted rendered corrected color to recalibrate or reprofile a rendering apparatus used to render the color.

6. The method of claim 5, comprising rendering an image using the recalibrated or reprofiled rendering apparatus.

7. A color rendering apparatus comprising:
a memory comprising a plurality of color prediction models for respective color rendering contexts, each color prediction model mapping between a device dependent color and a rendered color;
a processor to obtain measurement data of the rendered color in one context and map the measurement data to a corrected device color;
predict a corrected rendered color for the other contexts using the respective color prediction models and the corrected device color.

8. The apparatus of claim 7, comprising a printing apparatus having a printing device to render the device dependent color.

9. The apparatus of claim 7, comprising a measurement device to determine measurement data from a rendering context having the rendered device dependent color.

10. The apparatus of claim 7, the processor to control the apparatus to render a test pattern comprising the device dependent color in a said rendering context and to obtain measurement data corresponding to the rendered test pattern.

11. The apparatus of claim 8, the processor to determine the plurality of color prediction models by controlling the printing device to print the device dependent color for each respective rendering context and to obtain initial measurement data for each respective rendering context, and using the device dependent color and the initial measurement data for each rendering context to determine the respective color prediction models.

12. The apparatus of claim 7, wherein the rendering contexts comprise: printing substrates selected from the following group: paper, vinyl, textile, plastic; and post-processing is selected from the group: no post-processing, varnishing, laminating, calendering; display screens; a projection surface.

13. The apparatus of claim 7, the processor to use the predicted corrected rendered color to recalibrate or reprofile the rendering apparatus.

14. The apparatus of claim 7, comprising one of: a printing apparatus; a display screen; a projector for projecting onto a projection surface.

15. A non-transitory computer-readable storage medium comprising a set of computer-readable instructions that, when executed by a processor, cause the processor to:
determine a plurality of color prediction models for respective color rendering contexts, each color prediction model mapping between a device dependent color and a rendered color;
obtain measurement data of the rendered color in one said context and mapping the measurement to a corrected device color;
use the corrected device color to predict a corrected rendered color for another said context using the respective color prediction models.
